(19) United States
(12) Patent Application Publication
(10) Pub. No.: US 2017/0292025 A1
(43) Pub. Date: Oct. 12, 2017

(54) HEAT-DISSIPATING COATING AND A MANUFACTURING METHOD THEREOF

(71) Applicants: WHA YUEB TECHNOLOGY CO., LTD., TAOYUAN CITY (TW); M-VICTORY SPECIFIC MATERIAL CO., LTD., GUANGDONG PROVINCE (CN)

(72) Inventors: YU-CHIA CHEN, TAOYUAN CITY (TW); CHING-I CHOU, TAOYUAN CITY (TW)

(21) Appl. No.: 15/092,819

(22) Filed: Apr. 7, 2016

(51) Int. Cl. C09D 5/00; C23C 26/00; C09D 201/04; C09K 5/14; C09D 7/12

(52) U.S. Cl. CPC C09D 5/00; C09K 5/14; C09D 7/1216; C09D 201/04; C23C 26/00; C08K 3/04

(57) ABSTRACT

A manufacturing method for a heat-dissipating coating includes steps as: a) providing a gluey liquid mixed by a first solution and a compound substance at a weight ratio of 1:0.6 to 1:1.4; the compound substance is selected from a group consisting of fluorocarbon resin, fluororesin, acrylic acid resin, polyurethane, polyurea resin, unsaturated polyester, epoxide, and mixtures thereof; b) providing a filler material mixed by a second solution and a filler substance at a weight ratio of 1:0.3 to 1:0.8 and another weight ratio of the compound substance to the filler substance being 1:0.1 to 1:0.6; the filler substance is selected from a group consisting of bamboo charcoal, carbon nanotube, graphite, graphene platelets, graphene, carbon spheres, carbon fibers, BN, AlN, mica, SiO₂, TiO₂, SiC, ZnO, GeO₂, and mixtures thereof; c) mixing the gluey liquid and the filler material to produce a heat-dissipating material, so as to form a heat-dissipating coating.

### BACKGROUND OF THE INVENTION

### 1. Field of the Invention

The invention relates to a heat-dissipating compound piece and a manufacturing method thereof, particularly to a method that mixes a compound substance with a filler substance and produces a heat-dissipating coating with stain resistance and heat dissipation.

### 2. Description of the Related Art

Currently common elements for heat dissipation in the markets are expensive and are not suitable for light and handy products. Therefore, a coating method for heat dissipation is developed for applications. However, the existing coating materials for heat dissipation have flaws of intolerance of weatherability and low temperature, and less resistance to stains and chemicals. The dissipation efficiency of the product is decreased due to these defects. On the other hand, the existing filler substance for manufacturing the coating materials cannot dissipate the heat very well because the accumulation density of power ingredients is not taken into consideration for the manufacturing process.

As technology getting advanced, electronic devices are designed to be light and handy with highly functional chips. Heat dissipation is consequently more and more important to the devices. Currently the methods for heat dissipation are design of opening, heat conduction, and thermal convection. However, these methods are getting left behind the sophisticated electronic devices with even better technologies. Overheating is more and more common in the fields and tends to cause a lot of malfunctions of the devices. Therefore, it is obvious that improvements are urgent to overcome such problem.

### SUMMARY OF THE INVENTION

It is a primary object of the present invention to provide a heat-dissipating compound piece and a manufacturing method thereof with stain resistance and heat dissipation.

Another object of the present invention is to provide a coating with better heat dissipation to overcome problem of high temperatures of electronic devices during operation.

In order to achieve the objects above, the present invention comprises the following steps: a) providing gluey liquid mixed by a compound substance and a first solution, said compound substance being selected from a group consisting of fluorocarbon resin, fluororesin, acrylic acid resin, polyurethane, polyurea resin, unsaturated polyester, epoxide, and mixtures thereof; a weight ratio of said first solution to said compound substance ranging from 1:0.6 to 1:1.4; b) providing a filler material mixed by a filler substance and a second solution, said filler substance being selected from a group consisting of bamboo charcoal, carbon nanotube, graphite, graphene platelets, graphene, carbon spheres, carbon fibers, BN, AlN, mica, SiO2, TiO2, SiC, ZnO, GeO2, and mixtures thereof; a weight ratio of the compound substance to said filler substance ranging from 1:0.1 to 1:0.6 and a weight ratio of said second solution to said filler substance ranging from 1:0.3 to 1:0.8; c) filtering the gluey liquid and the filler material separately; d) mixing the filtered gluey liquid and filler material to produce a heat-dissipating material; and e) applying the heat-dissipating material produced in step d to a surface of an item and forming a heat-dissipating coating with a thickness between 3 um to 100 um after drying.

The hear-dissipating coating can be further applied to a surface of a metal piece so as to form a heat-dissipating compound piece to be disposed inside an electronic device, either near a heating source thereof or on the heating source. The metal piece includes at least one layer of heat conductive metal with a range of thickness between 3 um to 150 um, and it has a first surface and a second surface The heat-dissipating coating is applied to either or both of the first and second surfaces of the metal piece, so as to form a single-coated or double-coated heat-dissipating compound piece.

With techniques disclosed above, the present invention has better efficiency in stain resistance and heat dissipation.

### BRIEF DESCRIPTION OF THE DRAWINGS

FIG. 1 is a flow diagram of the present invention;

FIG. 2A is a schematic diagram illustrating a heat-dissipating coating of the present invention;

FIG. 2B is a partially enlarged view of area 2B in FIG. 2A;

FIG. 3 is an embodiment of a single-coated heat-dissipating compound piece according to the present invention;

FIG. 4 is an embodiment of a double-coated heat-dissipating compound piece according to the present invention;

FIG. 5 is an exploded view illustrating structure of a heat-dissipating compound piece applied to an electronic device in a practical application;

FIG. 6 is a perspective view of FIG. 5;

FIG. 7 is a sectional view along line 7-7 in FIG. 6;

FIG. 8 is a curve diagram with comparison of a bare aluminum piece (curve A) and an aluminum piece with heat-dissipating coating (curve B) according to the present invention; and

FIG. 9 is a perspective view of a heat-dissipating coating of the present invention under an electronic microscope.

### DETAILED DESCRIPTION OF THE PREFERRED EMBODIMENT

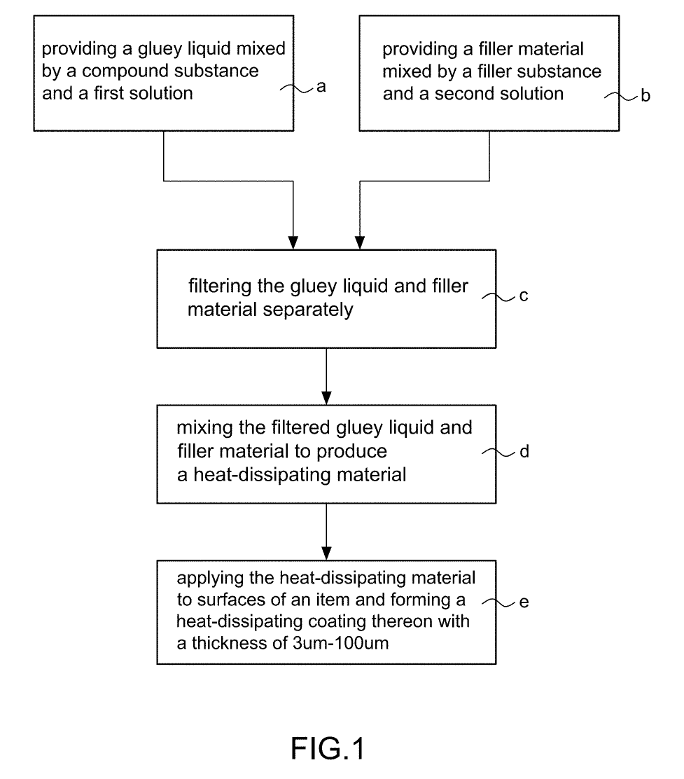

Referring to FIG. 1, a method for manufacturing a heat-dissipating coating includes steps as following.

Step a: providing gluey liquid 10 mixed by a compound substance and a first solution with a weight ratio of the first solution to the compound substance ranging from 1:0.6 to 1:1.4. The compound substance is selected from a group consisting of fluorocarbon resin, fluororesin, acrylic acid resin, polyurethane, polyurea resin, unsaturated polyester, epoxide, and mixtures thereof. In this embodiment, the first solution is selected from a group consisting of thinner, ethyl acetate, ethanol, distilled water, and mixtures thereof.

Step b: providing a filler material 20 with porosity structure which is mixed by a filler substance and a second solution with a weight ratio of the compound substance to the filler substance ranging from 1:0.1 to 1:0.6 and a weight ratio of the second solution to the filler substance ranging from 1:0.3 to 1:0.8. The filler substance is selected from a group consisting of bamboo charcoal, carbon nanotube, graphite, graphene platelets, graphene, carbon spheres, carbon fibers, BN, AlN, mica, SiO2, TiO2, SiC, ZnO, GeO2, and mixtures thereof. In this embodiment, the filler substance is preferred to have porosity structure, but it can be mixed with components with or without porosity, or a mixture of partial porous components and partial ones without porosity. The second solution is selected from a group consisting of thinner, ethyl acetate, ethanol, distilled water, and mixtures thereof.

Step c: filtering the gluey liquid 10 and the filler material 20 separately. In this embodiment, the gluey liquid 10 and the filler material 20 are filtered by a filter with 350 meshes.

Step d: mixing the filtered gluey liquid 10 and filler material 20 to produce a heat-dissipating material 30. In this embodiment, a high shear emulsifier is applied to mix for 10 minutes and then produce the heat-dissipating material 30.

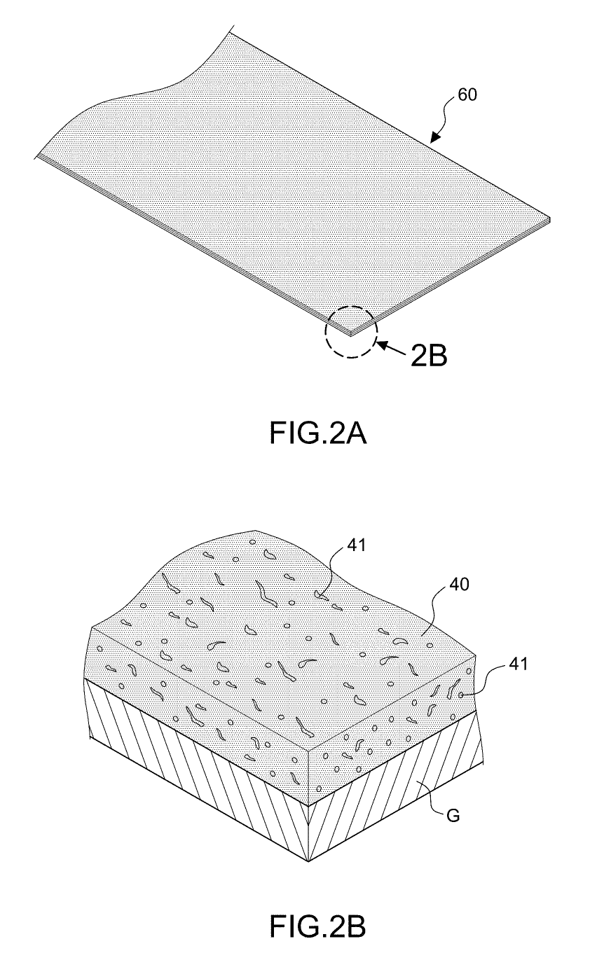

Step e: applying the heat-dissipating material 30 produced in step d to a surface of an item G and forming a heat-dissipating coating 40 with a thickness between 3 um to 100 um after drying as shown in FIGS. 2A and 2B. In this embodiment, the item G is a metal piece or a heating source; and the heat-dissipating coating 40 has porosity structure 41 with reference to a photo taken under an electronic microscope in FIG. 9.

Based on the manufacturing method and structures disclosed above, in a preferred embodiment, the heat-dissipating material 30 has the gluey liquid 10 mixed by a compound substance of fluorocarbon resin in 120 g mixed with a first solution of ethyl acetate in 100 g, and the filler material 20 mixed by a filler substance of bamboo charcoal in 30 g mixed with a second solution of distilled water in 100 g, both are then filtered by a filter with 350 meshes and mixed by a high shear emulsifier for 10 minutes, so as to produce the heat-dissipating material 30.

In another embodiment, the present invention has the gluey liquid 10 consisted of a compound substance of fluorocarbon resin in 120 g mixed with a first solution of thinner in 100 g, and the filler material 20 consisted of a filler substance of Nano bamboo charcoal in 30 g mixed with a second solution of ethyl acetate in 60 g, and then going through the same manufacturing process as described to produce the heat-dissipating material 30.

In these embodiments, fluorocarbon resin is the ingredient for the compound substance since the fluorine produced thereby has strong electronegativity and carbon-fluorine bond, enabling features as weatherability, heat resistance, low temperature resistance, and chemical resistance. Consequently, the heat-dissipating material 30 is stain resistance and environmental friendly. As for other ingredients such as fluororesin, acrylic acid resin, polyurethane, polyurea resin, unsaturated polyester, and epoxide, they have the same effect in practical applications as well. The filler substance is selected from bamboo charcoal, carbon nanotube, graphite, graphene platelets, graphene, carbon spheres, carbon fibers, BN, AlN, mica, SiO₂, TiO₂, SiC, ZnO, GeO₂, or mixtures thereof since these ingredients has intense porosity structures 41 for increasing surface area of the heat-dissipating material 30 to dissipate the heat efficiently. Plus, these ingredients produce high radiation energy and low enthalpy to assist the heat dissipation as well. The first and second solutions selected from thinner, ethyl acetate, ethanol, distilled water, or mixtures thereof have better dissolution effects to ensure the filler substance well mixed.

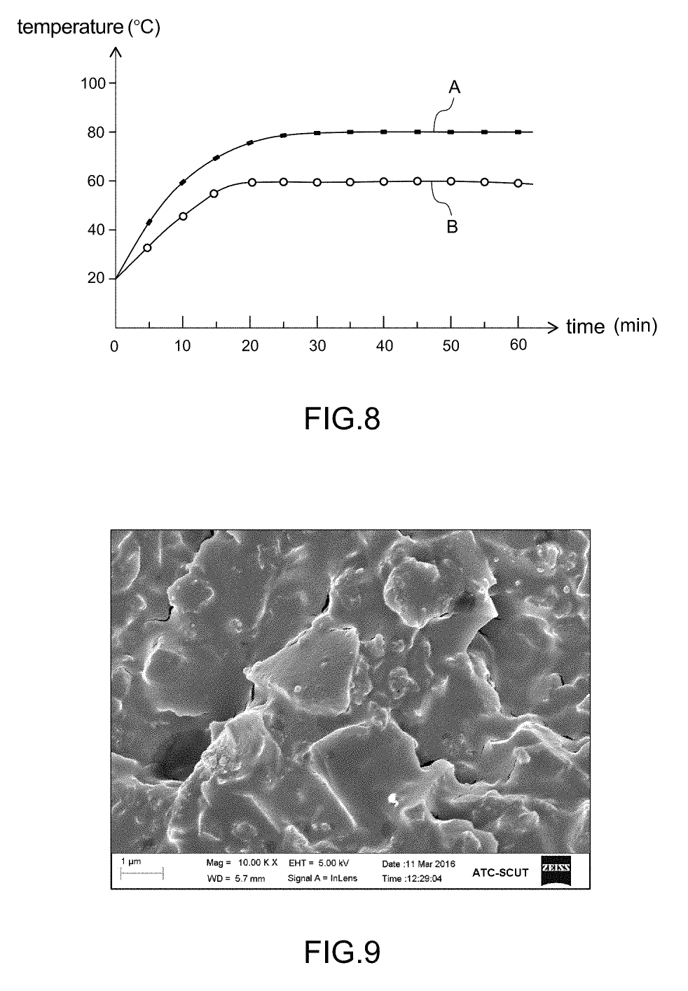

In an experiment of heat dissipation efficiency of the heat-dissipating coating 40, there are two aluminum pieces with measurements of 140 mm*700 mm*3 mm, which is about the size of a 5″ smartphone. One of the aluminum pieces is left bare as the control group and the other one is applied the heat-dissipating coating 40 with a 100 um thickness as the experiment group. Then the aluminum pieces are put onto a heating item with a constant 38V output for observation. As shown in FIG. 8, a curve A represents the temperature changes of the control group and a curve B represents the one of the experiment group. By comparing the curves we can learn that the experiment group has the temperature rising within a shorter period and reaching a lower degree than the control group, indicating that the heat conduction of the experiment group is faster; in other words, the heat-dissipating coating 40 of the present invention has better efficiency in heat conduction and dissipation.

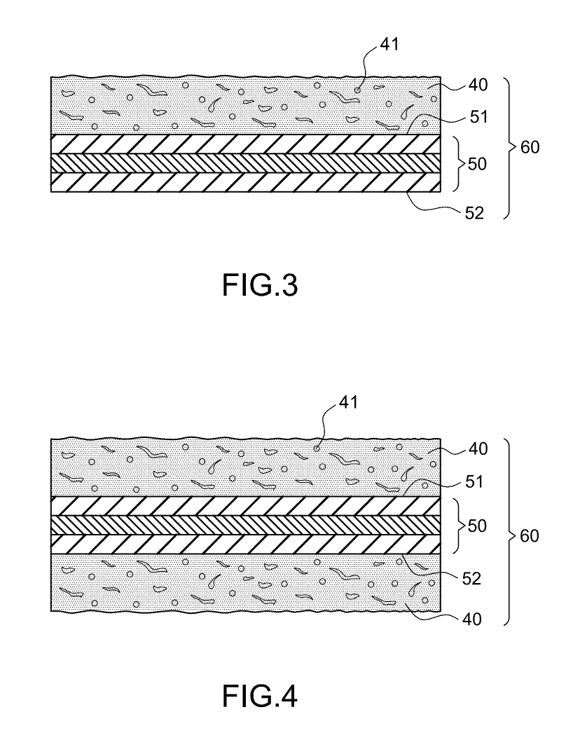

Referring to FIG. 3, the heat-dissipating coating 40 is applied to a surface of a metal piece 50 to form a heat-dissipating compound piece 60. The compound piece can be further disposed inside an electronic device 70, either near a heating source or right on the heating source. The metal piece 50 comprises at least one layer of heat conductive metal with a thickness between 3 um to 150 um, and the metal piece 50 further includes a first surface 51 and a second surface 52. The heat-dissipating coating 40 is then applied to either of the surfaces to form a single-coated heat-dissipating compound piece 60. Moreover, referring to FIG. 4, the heat-dissipating coating 40 is applied to both of the surfaces to form a double-coated heat-dissipating compound piece 60. The heat-dissipating coating 40 can also be applied to a surface of a non-metal item or a surface of a thermal balancing layer for even better efficiency.

In this embodiment, the metal piece 50 can be either two-dimensional or three-dimensional. It is a single layer piece selected from a group consisting of Cu, Al, Ti, Ag, copper alloy, aluminum alloy, Ag alloy, Titanium alloy, and stainless steel. The functions of the metal piece 50 is conducting, dissipating, and constructing. It can also be a compound metal piece selected from the group for application.

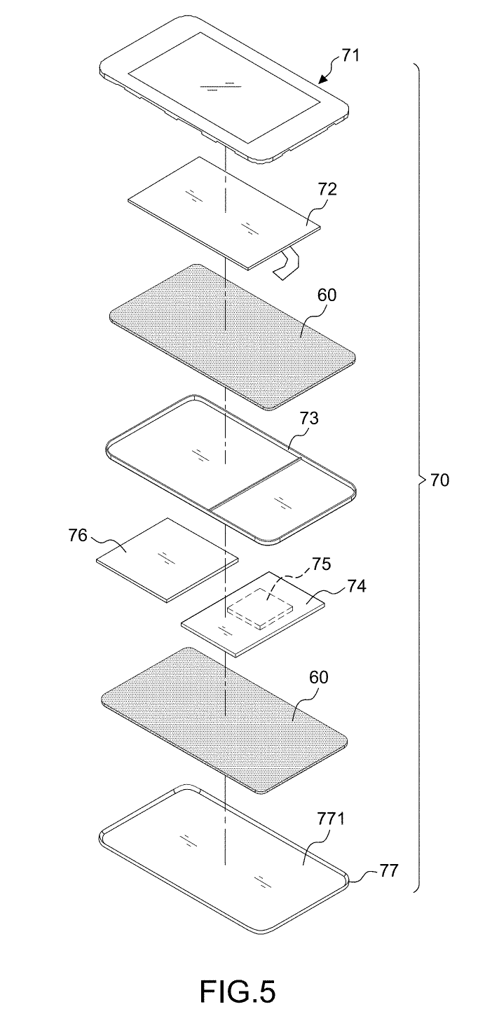

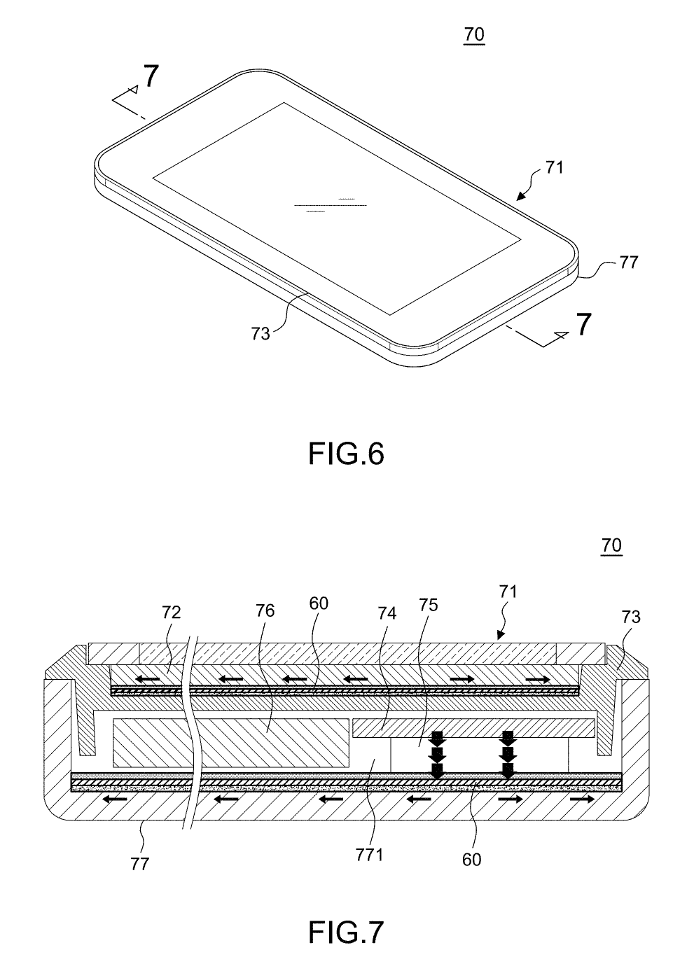

FIGS. 5-7 illustrated the heat-dissipating compound piece 60 applied to an electronic device 70. The device mainly includes a touch panel 71, a LCD display module 72 disposed under the touch panel 71, an outer frame 73 disposed under the display module 72, a PCB 74 with at least one electric chip 75 disposed under the outer frame 73 together with a battery 76, and a back plate 77 correspondingly engaging the outer frame 73, defining a space 771 for the components disclosed above. With the heat-dissipating compound piece 60, the electronic device 70 can further achieve better heat dissipation in operation.

In short, the present invention has the heat-dissipating compound piece 60 to assist in heat dissipation for electronic devices. It can be manufactured in a suitable size for the device and then disposed near the heating source or it can be directly manufactured together in one piece with components of the heating source. Therefore the present invention has functions as heat dissipation, heat conduction and thermal balance to ensure the electronic devices to be safe and reliable, and decrease the cost for manufacturing. Also, the metal materials can also provide physical supports for the structure.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A method for manufacturing heat-dissipating coating, comprising:
a) providing gluey liquid mixed by a compound substance and a first solution, said compound substance being selected from a group consisting of fluorocarbon resin, fluororesin, acrylic acid resin, polyurethane, polyurea resin, unsaturated polyester, epoxide, and mixtures thereof; a weight ratio of said first solution to said compound substance ranging from 1:0.6 to 1:1.4;
b) providing a filler material with porosity structure which is mixed by a filler substance and a second solution, said filler substance being selected from a group consisting of bamboo charcoal, carbon nanotube, graphite, graphene platelets, graphene, carbon spheres, carbon fibers, BN, AlN, mica, SiO₂, TiO₂, SiC, ZnO, GeO₂, and mixtures thereof; a weight ratio of the compound substance to said filler substance ranging from 1:0.1 to 1:0.6 and a weight ratio of said second solution to said filler substance ranging from 1:0.3 to 1:0.8;
c) filtering the gluey liquid and the filler material separately;
d) mixing the filtered gluey liquid and filler material to produce a heat-dissipating material; and
e) applying the heat-dissipating material produced in step d to a surface of an item and forming a heat-dissipating coating with a thickness between 3 um to 100 um after drying.

2. The method as claimed in claim 1, wherein the first and second solution are selected from a group consisting of thinner, ethyl acetate, ethanol, distilled water, and mixtures thereof.

3. The method as claimed in claim 2, wherein the gluey liquid in step a consists of a compound substance of fluorocarbon resin in 120 g mixed with a first solution of ethyl acetate in 100 g, and the filler material in step b consists of a filler substance of bamboo charcoal in 30 g mixed with a second solution of distilled water in 100 g.

4. The method as claimed in claim 1, wherein the item in step e is a metal piece or a heating source.

5. A heat-dissipating compound piece, comprising:
a heat-dissipating coating produced by the method in claim 1 to be applied to a surface of a metal piece, so as to form a heat-dissipating compound piece to be disposed inside an electronic device, either near a heating source thereof or on the heating source;
wherein the metal piece comprising at least one layer of heat conductive metal with a thickness between 3 um to 150 um, said metal piece further including a first surface and a second surface; and
wherein the heat-dissipating coating is applied to either or both of the first and second surfaces of the metal piece, so as to form a single-coated or double-coated heat-dissipating compound piece.

6. The heat-dissipating compound piece as claimed in claim 5, wherein the metal piece is a piece of single layer or multiple layers selected from a group consisting of Cu, Al, Ti, Ag, copper alloy, aluminum alloy, Ag alloy, Titanium alloy, stainless steel, and any combination thereof.
